(19) United States
(12) Patent Application Publication
(10) Pub. No.: US 2019/0003896 A1
(43) Pub. Date: Jan. 3, 2019

(54) SENSOR PROBE SUPPORT

(71) Applicant: CamLab Limited, Cambridge Cambridgeshire (GB)

(72) Inventors: Rowan David Maulder, Cambridge Cambridgeshire (GB); Darren John Smith, Suffolk (GB)

(21) Appl. No.: 15/735,917

(22) PCT Filed: Jun. 10, 2016
(86) PCT No.: PCT/GB2016/051745

§ 371 Date: Dec. 12, 2017

(30) Foreign Application Priority Data
Jun. 12, 2015 (GB) 1510358.3

(51) Int. Cl. G01K 1/14; G01D 11/30

(52) U.S. Cl. CPC G01K 1/14; G01K 7/16; G01D 11/30

(57) ABSTRACT

A sensor probe support for supporting a sensor probe using a wall, the sensor probe support comprising a member and a connector to moveably connect the member 18 to and space the member from a sensor probe. The member projects longitudinally from the connector. The member comprises a curve transverse surface. In use, a wall such as a sidewall of a beaker is located between a sensor probe and the member to support the sensor probe.

### FIELD OF THE INVENTION

The present invention relates to a sensor probe support for supporting a sensor probe, such as an electrochemical sensor (for example, for pH, ion-selective, dissolved oxygen, or conductivity measurement), a temperature sensor or the like. More specifically, it relates to a system for supporting a sensor probe and providing wireless communication for the sensor probe.

### BACKGROUND OF THE INVENTION

Electrical sensors are well known in the measurement and instrumentation industry. They are used widely in laboratories and in the field to measure physical and chemical properties of samples. A typical electrical sensor is an electrochemical sensor such as pH, ion-selective, dissolved oxygen or conductivity electrode or a temperature sensor. They are available commercially in several different form factors. Such sensors are commonly available as electrical sensor probes, sometimes referred to as electrodes, in which the sensor components are housed in, or form part of, a probe body which is typically made from glass or plastic.

A meter may have both an electrochemical sensor and an electronic temperature sensor fitted to it. This is because the parameters being measured by the electrochemical sensor may be altered by the temperature of a solution under test and so both parameters need to be measured for an accurate electrochemical sensor reading. Such temperature sensors may be resistive such as a thermistor, RTD (resistance temperature detector) or PRT (platinum resistance thermometer) or actively producing current with respect to a temperature differential across them such as a thermocouple.

Typically, voltages in the order of millivolts are output from these sensors and these voltages are interpreted by a meter to provide units relative to the physical or chemical process being measured.

Typically, sensor probes are used in combination with a support, or stand, of some type. These supports are generally accepted as an extension of the probe apparatus, as in order to take accurate measurements it is desirable that the tip of a sensor probe is immersed in a sample, and for certain types of probe it is important that the probe tip does not rest on the base of the sample container. A support may also be necessary to stop a sensor probe overbalancing, for example if a tall sensor probe is placed in a relatively short-sided sample container, and particularly where a cable is connected to the upper-end of the sensor probe.

The support may be a traditional retort stand, or clamp stand, such as those commonly found in chemistry laboratories. The sensor probe is clamped to the retort stand by an arm and a bosshead, which may be vertically lowered and raised in order to position the sensor probe and take a measurement from a sample on a laboratory bench. The arm, or clamp, may be specially adapted to hold one or more sensor probes by attaching a moulded member comprising slots into which sensor probes of a standard size may fit. Whether or not the retort stand is adapted for sensor probes, such an arrangement is extremely cumbersome, due to the necessity of repeatedly loosening and tightening the bosshead in order to fix the height of the sensor probe, and having to raise and lower the clamped probe in between samples. There is also a significant possibility of damage to the sensor probe if the clamp is tightened to too great an extent, or if the arm slips down the retort stand due to improper tightening of the bosshead.

More sophisticated cantilever stands, comprising a plurality of posable joints, are also commonly used to support sensor probes for bench-top applications. Such stands offer a greater degree of flexibility, as once a sensor probe is held by the stand it may be positioned in, and removed from, a sample by manipulating the stand without the need to tighten any clamps or screws. Unlike a traditional retort stand, cantilever stands allow a greater degree of lateral movement of the sensor probe while maintaining the base of the stand in the same position on the laboratory bench.

While cantilever stands offer an improved degree of movement for an attached probe, both retort and cantilever stands are relatively bulky and impractical to move. These stands are therefore highly impractical for use outside laboratories, such as during field-work, where compact sensor probes are otherwise highly applicable. This means that both types of stand are essentially restricted to bench top laboratory use, wherein a user is forced to bring samples to the stationary sensor probe and sensor probe support for testing. This leads to working practices that are unnecessarily time consuming, and limits the utility of sensor probes so that they are effectively fixed bench top instruments. The design of existing sensor probe supports therefore significantly limits the practicality of these otherwise versatile sensor probes.

Typically, sensor probes are connected to meters which have a display or output of some type, so that the measurement from the sensor probe may be read. Two examples of meters are bench mounted meters and handheld meters. Bench mounted meters are designed to be left in a fixed place and connected by cables to the relevant sensor. Handheld meters often have an electric sensor permanently attached to them via a connector, or a cable and connector assembly.

The presence of cables, even in a fixed location benchtop meter such as may be found in a laboratory, can be a significant inconvenience or indeed safety hazard when dealing with chemicals. They may even preclude the measurement of chemical attributes in some situations. For example, this may be due to the requirement to route the cables from the vessel that a chemical is contained in, to the meter that is situated outside the container. Alternatively, this may be due to the requirement to situate the meter far from the sensor, as might be the case when measuring water in a river from a bridge so that the integrity of the sensor output may be impaired.

Each meter has a physical and electronic termination for the sensor output. For this reason, most meters only have the capability to connect to a single sensor at a time, meaning that many meters are required to measure multiple attributes of even a single experiment. These multiple meters might then have to have logging performed simultaneously, either manually, by one or more operators, or digitally, by one or more computing devices.

Recent attempts to eliminate some of these problems have led to the creation of wireless meters that communicate with wireless electrochemical sensor probes using WiFi, GPRS, Bluetooth and more recently the Bluetooth 4.0 (registered trade mark) wireless communications protocol.

Eliminating the connecting cables necessarily leads to some degree of independence in the positioning of sensor probes and meters. However, the usefulness of wireless sensor probes is still greatly limited by known sensor probe supports.

For example, the HI11312 HALO (trade mark) of Hanna Instruments, Inc is a wireless pH probe which uses Bluetooth (registered trade mark) Smart technology to transmit measurement data to an Apple iPad (registered trade mark) tablet computer running a dedicated application. The HALO probe is marketed in combination with a cantilever-style electrode holder.

### BRIEF SUMMARY OF THE INVENTION

No sensor probe support currently exists to allow electrical sensor probes to be firmly and precisely located remotely from one of the bench top supports described previously. In the absence of such bulky supports, sensor probes must currently be held in position by hand during measurements, which is highly inconvenient for measurements lasting more than a few seconds. Additionally, without a support to hold them upright, such sensor probes are typically stored on their sides in between measurements. This can be potentially damaging to the sensor probe, and can lead to inaccurate measurements, as electrolyte contained within the probe may leak from, or move within, the probe body.

Embodiments of the invention described herein provide a sensor probe support for supporting a sensor probe using a wall. Preferably, the sensor probe support is for supporting a sensor probe using a wall of a container or beaker. In an alternative embodiment the invention described herein provides a system for supporting a sensor probe using a wall and providing wireless communication for the sensor probe. Preferably, the system provides wireless communication to a meter. Preferably the meter is an electronic device such as a smart phone or mobile phone, or computer (for example, a general purpose computer such as a laptop computer, desktop computer (PC) or tablet computer). Preferably, the wireless transmission protocol from sensor probe to electronic device is Bluetooth (registered trade mark) and, in particular, Bluetooth Smart (registered trade mark), which is the low energy variant of Bluetooth.

The invention in its various aspects is defined in the independent claims below to which reference should now be made. Advantageous features are set forth in the dependent claims.

Generally, arrangements described herein relate to a sensor probe support for supporting an electrochemical sensor probe or other sensor probe or sensor probes using a wall such as a sidewall or a container or a beaker. The sensor probe support is a very simple arrangement.

Arrangements are described in more detail below and take the form of a sensor probe support, otherwise known as a sensor probe holder, for supporting a sensor probe using a wall.

A sensor probe, which may alternatively be referred to as a sensor, or a probe, or an electrode, comprises a sensor for sensing a physical and/or chemical property of a sample. Typically, a sensor probe comprises a sensor housed in, or forming part of, a probe housing. The probe housing of a sensor probe is commonly a substantially cylindrical housing, having a distal end and a proximal end, and being formed from a material such as a plastic or a glass or a metal. The operative components of the sensor are typically housed in, or located so as to terminate in, the distal end of the probe housing, otherwise referred to as the probe tip, so that a measurement may be taken by bringing the probe tip into contact with a sample to be measured. The probe housing may be hollow, and may contain or comprise electronic communications, batteries and/or electrolyte material forming part of the sensor. The proximal end of the probe housing may typically comprise an adaptor configured to provide a connection from the sensor to a meter of some sort, so that the parameters sensed by the sensor may be measured.

A sensor probe as referred to herein may comprise any of a variety of typical electrical sensors, for example an electrochemical sensor such as a pH, ion-selective, dissolved oxygen or conductivity electrode, or a temperature sensor.

In an aspect of the present invention, there is provided a sensor probe support for supporting a sensor probe using a wall, the sensor probe support comprising: a member; and a connector to moveably connect the member to and space the member from a sensor probe, the member projecting from the connector; wherein, in use, a wall is located between a sensor probe and the member to support the sensor probe.

The sensor probe support may advantageously be configured to support a sensor probe using a wall of a container. Preferably, the support may be configured to support a sensor probe using a wall of a container containing a sample to be measured. Particularly preferably, the sensor probe support may be configured to support a sensor probe using either a curve wall or a straight wall.

The connector may advantageously be releasably connectable to a sensor probe. The connector may be configured to clip on to a sensor probe, or to slide on to a sensor probe, or to clamp on to a sensor probe. For example, the connector may comprise a through hole with a circular circumference to connect the member to a sensor probe such as a temperature probe or the like. The through hole may comprises an outwardly projecting rim to aid in supporting the sensor probe. The connector may comprise an indent to connect the member to a sensor probe such as an electrochemical sensor or the like. The indent may have a partially circular edge with an opening facing away from the member at its free ends. The free ends may be resilient in order to allow a sensor probe to be entered into the indent, for example by pushing he probe into the indent such that the space between the free ends of the indent is widened and then reduced as the sensor probe is located in the indent such that it is held in the indent.

The connector may preferably be configured to connect the member to and space the member from a circularly cylindrical sensor probe. The connector may preferably be configured to connect to a commercially available circularly cylindrical sensor probe of a standard diameter.

The connector may be permanently and/or rigidly connected to or integral with the member such that, when the connector is connected to a sensor probe, the member projects from the connector in a direction that is substantially parallel to the longitudinal axis of the sensor probe. The sensor probe support may be formed from two or more connected pieces, as a single piece or as a unitary device. When the connector is connected to a sensor probe, in use, the member preferably extends parallel to the probe, towards the distal end of the sensor probe and the probe tip.

The dimensions of the connector may determine the spacing between the member and a sensor probe to which the connector is connected. The dimensions of the connector may thus advantageously determine the width of wall which may located, in use, between a sensor probe and the member to support the sensor probe. The dimensions of the connector may be chosen so that the spacing between a connected sensor probe and the member is slightly greater than the width of the wall of a typical sample container, for example the wall of a glass laboratory beaker.

The sensor probe support advantageously allows a connected sensor probe to be intentionally easily attached and removed from a wall by a user as the sensor probe and connected support may simply be lifted off and placed on to a wall without loosening any resilient or movable elements. This effectively allows the sensor probe and sensor probe support to be used with a single hand, where a second hand would be needed to safely disconnect a resilient element from the wall of, for example, a sample container. However, it is difficult for a user to unintentionally detach the sensor probe support from the wall.

The sensor probe support may be formed from plastics.

The connector and the member may be formed from the same material. Particularly preferably, the connector and the member may be formed from a single piece of material.

The weight of the sensor probe support is preferably less than the weight of a typical sensor probe. Particularly preferably, the weight of the sensor probe support may be less than 200 grams, or less than 100 grams, or less than 75 grams, or less than 50 grams. The low weight of the sensor probe support may advantageously allow it to be used to support sensor probes on the walls of lightweight containers, or on the walls of containers containing only a small mass of sample, or of liquid, without causing the container to overbalance. This may be particularly useful in situations where lightweight plastic containers are used to contain samples, or where the walls of a container slope outwards from the base, such as is the case with many plastic cups.

The connector may preferably moveably connect the member to and space the member from a sensor probe at a number of predetermined positions on the sensor probe. The connector may advantageously be moveably connectable to a sensor probe at any position between the distal end and the proximal end of the sensor probe. Particularly preferably, when the connector is connected to a sensor probe it may be moveable, or slideable, along the sensor probe to a desired position between the distal and proximal ends of the sensor probes. The force required to move or slide the connected connector along the probe may advantageously be greater than the weight of the sensor probe, such that when the sensor probe and sensor probe support are supported by a wall, in use, the sensor probe is held stationary with respect to the connector. The resilience of the connector is such that it holds the sensor probe in place, but can be forced by a user to allow the sensor probe to move intentionally.

The connector may be connectable to a sensor probe at a plurality of predetermined positions. Preferably, the connector may be connectable to a sensor probe at any position along the length of the probe. Alternatively, the connector may be connectable to a sensor probe at a predetermined position, and moveable along the sensor probe once connected.

The fact that the sensor probe support is moveably connectable to a sensor probe may advantageously allow the adjustment of the vertical height at which the sensor probe is supported by the sensor probe support and a wall. This may advantageously allow the height of the sensor probe according to the height of the wall upon which it is supported, in use, and/or the volume of sample to be measured by the probe.

The sensing components of sensor probes are typically situated in or near the distal end of the probe housing. In order that chemical species in a sample interact properly with the sensing components of the sensor probe, it is therefore important that the distal end of the sensor probe is in contact with the sample and not, for example, with the bottom of the sample container. Contact with the bottom of the sample container may introduce errors into measurements. In addition, the sensing components of certain types of sensor probe, for example pH sensor probes, are made of a fragile and specially conditioned glass. If the adjustment of the sensor probe height or manual insertion into a container is not carefully controlled, contact with the bottom of the container may easily break the fragile tip of the sensing component, releasing the internal chemical solution (electrolyte) and also creating broken glass which contaminates the sample. This is inconvenient and hazardous, and also leads to the costly replacement of the entire sensor probe.

In order to obtain an accurate reading from the sensor probe, a user should therefore ensure that the probe tip is suspended in the (liquid) sample throughout the measurement. For consistency, the probe tip should ideally be suspended at the same depth each time a measurement is taken. With the supports of the prior art this is cumbersome, particularly with small sample volumes, as for every new sample the height of the retort or cantilever stand must be manually reset so that the probe tip is held between the sample surface and the base of the container. This also creates a potential source of error when taking sensor probe measurements by hand, without a devoted sensor probe support, as a user may end up obscuring the probe tip with the base of the container accidentally, particularly if a measurement is being taken over a significant period of time. Measurements taken by hand may also be subject to errors caused by inconsistent immersion depths and inconsistent angles of insertion.

The moveable connection of the support according to the present invention allows this height adjustment to be done quickly and easily according to the size of a sample container and/or the depth of the sample to be measured. The sensor probe may therefore be transferred quickly between samples either without adjusting the position of the sensor probe support, or quickly moving the sensor probe support to compensate for changes in the samples and/or sample containers. Once the sensor probe support and connected sensor probe are supported by the wall of a sample container, in use, the sensor probe may be supported at the desired height for the duration of a measurement, or until removal by a user.

In use, the sensor probe support is connected to a sensor probe by connecting the connector to a sensor probe such that the member is spaced from the sensor probe by the connector and projects from the connector in the same direction as the distal end of the sensor probe. The sensor probe support is then positioned by a user such that a wall is located between the sensor probe and the member, with the distal end of the sensor probe projecting in a downwards direction on one side of the wall, and the member projecting in a downwards direction on the other side of the wall. Preferably, the distal end of the sensor probe may be immersed in a sample for measurement by the sensor probe. The upper edge of the wall is brought into contact with the connector of the sensor probe support, such that the sensor probe is supported by the sensor probe support using the wall.

Preferably the sensor probe support provides, in use, at least two points of contact with the wall or one point of contact between the sensor probe support and the wall and one point of contact between the sensor probe supported in the sensor probe support and the wall. Alternatively, the sensor probe support and the sensor probe supported in the sensor probe support together provide at least three points of contact with the wall including two points of contact between the sensor probe support and the wall and one point of contact between the sensor probe in the sensor probe support and the wall. Particularly preferably, the sensor probe support may provide, in use, at least one point of contact with an upper edge of the wall, and at least one point of contact with a side portion of the wall. The sensor probe is thus held stably in place on the wall by its own weight, by points of contact between the sensor probe support and the wall or between the sensor probe, sensor probe support and the wall, and by the shape of the sensor probe support, without the need to tighten any screws or adjust any fastening elements. Once a measurement has been taken, the sensor probe and sensor probe support may be removed from the wall while still connected, and may be rinsed or placed onto another wall, for example the wall of another sample container.

In another aspect of the present invention, there is provided a sensor probe support for supporting a sensor probe using a wall, the sensor probe support comprising: a member comprising a curve transverse surface; and a connector to connect the member to and space the member from a sensor probe, the member projecting longitudinally from the connector; wherein, in use, a wall is located between a sensor probe and the curve surface of the member to support the sensor probe.

Preferably the sensor probe support according to the present invention may be usable to support sensor probes using walls of various types and shapes. Particularly preferably, the sensor probe support may be usable to support sensor probes using the walls of containers of the sort commonly found in laboratories, particularly those containers commonly used for sample storage and/or analysis. For example, the sensor probe support may advantageously be usable to support a sensor probe using the curve walls of glass or Pyrex (registered trade mark) beakers or the like, plastic sample cups and threaded or unthreaded plastic sample tubes and centrifuge tubes, as well as flat sided containers.

In order to be usable with a variety of containers over a wide range of container-volumes, the sensor probe support should be able to accommodate walls over a large range of curvatures. The support should also be able to accommodate common container features such as flat, rounded or curved lips, or rims, which are common on laboratory glassware and plasticware.

As described previously, when the connector is connected to a sensor probe, the member preferably projects from the connector in a direction that is substantially parallel to the longitudinal axis of the sensor probe. The member may advantageously comprise a curve transverse surface of the member in order to help hold and stabilise the support to a wall.

The sensor probe support may be configured to connect to only one, or a single, sensor probe. Preferably the connector may be configured to connect to the sensor probe at a central portion of the connector, so that, in use, the central axis of the sensor probe is aligned with the centre of the member. Preferably, the connector probe may connect to a sensor probe at a central portion of the connector so that, in use, weight of the sensor probe is spread evenly across the sensor probe support and the supporting wall.

In another aspect of the present invention, there is provided a sensor probe support for supporting at least two sensor probes using a wall, the sensor probe support comprising: a member; and a connector to connect the member to and space the member from at least two sensor probes, the member projecting from the connector; wherein, in use, a wall is located between the at least two sensor probes and the member to support the at least two sensor probes.

Of the at least two sensor probes, one probe may advantageously be a temperature sensor, while another probe may advantageously measure a different physical or electrochemical property, particularly preferably a physical or chemical property that varies according to temperature.

According to this arrangement, both of the at least two sensor probes may be held at a constant separation during measurement, which may eliminate any errors introduced by varying the positions of sensor probes during measurements. This arrangement may additionally allow measurement of more than one parameter simultaneously, which may be of particular benefit where such parameters are changing rapidly.

The connector may be releasably connectable to both sensor probes. The connector may be releasably connectable to one sensor probe, and permanently connected to the second sensor probe.

In another aspect of the present invention, there is provided a sensor probe support comprising: at least one member; and a connector to connect the at least one member to and space the at least one member from a sensor probe, the at least one member projecting from the connector; wherein, in use, a wall is located between the sensor probe and the at least one member, such that there are at least two points of contact between: the wall and the sensor probe support and the sensor probe; or the wall and the sensor probe support.

Preferably the sensor probe support and connected sensor probe may be supported, in use, using a wall which contacts the sensor probe support and/or the connected sensor probe in at least two contact points. Preferably, when the sensor probe support and connected sensor probe are supported by a wall, in use, there are at least two, preferably at least three, contact points between the wall and the sensor probe support and/or between the wall and the sensor probe. The contact points may be formed by a point of contact between the wall and the sensor probe, or the wall and the connector, or the wall and the member. The contact points may vary depending on the curvature and thickness of the wall.

In another aspect of the present invention, there is provided a method of supporting a sensor probe using a wall, comprising the steps of: connecting a sensor probe support to a sensor probe using a sensor probe connector, such that a member projecting from the connector is connected to and spaced from the sensor probe; and locating a wall between the sensor probe and the member, such that the sensor probe and sensor probe support are supported by the wall.

The sensor probe connector may be connected to the sensor probe by clipping the connector on to the sensor probe, or sliding the connector on to the sensor probe, or fastening the connector on to the sensor probe.

The sensor probe support may preferably be connected to a sensor probe such that the member projecting from the connector projects towards the distal end of the sensor probe.

Particularly preferably, the sensor probe support may be connected to a sensor probe such that the member projecting from the connector projects in a direction that is parallel to a longitudinal axis of the sensor probe.

The method may comprise a method of supporting a sensor probe using a wall of a container, particularly preferably a wall of a container which contains a liquid sample to be measured by the sensor probe.

The method may comprise the additional step of moving the sensor probe connector to a desired position between the distal end and the proximal end of the sensor probe, such that the sensor probe is supported by the wall at a desired height. The desired height may be a height at which the distal end of the sensor probe is immersed in a liquid sample adjacent the supporting wall.

In another aspect of the present invention, there is provided a system for providing a measurement from a sensor probe, comprising: a sensor probe; and a sensor probe support comprising: a member; and a connector to connect the member to and space the member from the sensor probe, the member projecting from the connector; wherein, in use, a wall is located between the sensor probe and the member to support the sensor probe.

The system may comprise a plurality of sensor probes, connectable to the same sensor probe support. Preferably, one sensor probe may comprise a temperature sensor probe.

The sensor probe support may be attachable to the one or more probes by a sliding the one or more probes into the support. The sensor probe support may be attachable to the one or more probes by clipping the sensor probe to the sensor probe support.

The system may comprise an adaptor, connectable to the one or more sensor probes so as to provide a connection from the one or more sensor probes to a meter. Preferably the adaptor may connect to the one or more sensor probes simultaneously. The adaptor may be connectable to the one or more sensor probes by a screw or twist thread, an S7 or BNC connector, or by various other types of commercially available sensor probe connectors.

The adaptor may comprise a sensor interface for interfacing with a sensor, such as an electrochemical sensor or a temperature sensor or the like. The adaptor may allow the digitising of one or more analogue voltages from the one or more sensors into a digital format for transmission, or storage for transmission at a later time, to a meter.

The system may additionally comprise a meter. Preferably, the meter is an electronic device such as a smart phone or mobile phone, or computer (for example, a general purpose computer such as a laptop computer, desktop computer (PC) or tablet computer). Preferably, the electronic device includes appropriate software or an app or application to act as a meter.

Preferably, the adaptor, or sensor interface, may provide for wireless transmission of data to a meter.

The wireless transmission protocol from sensor interface, or adaptor, to electronic device may be WiFi or the like. Preferably, the wireless transmission protocol from sensor interface, or adaptor, to electronic device is Bluetooth (registered trade mark) and, in particular, Bluetooth Smart (registered trade mark), which is the low energy variant of Bluetooth.

A preferred embodiment of the invention is described in more detail below and takes the form of a sensor probe support for supporting a sensor probe using a wall, the sensor probe support comprising a member and a connector to moveably connect the member to and space the member from a sensor probe. The member projects longitudinally from the connector. The member comprises a curve transverse surface. In use, a wall such as a sidewall of a beaker is located between a sensor probe and the member to support the sensor probe.

### BRIEF DESCRIPTION OF THE DRAWINGS

The invention will be described in more detail, by way of example, with reference to the accompanying drawings, in which:

FIG. 1 shows a retort stand forming part of the prior art;

FIG. 2 shows a cantilever-type stand forming part of the prior art;

FIG. 3 shows a perspective view of a sensor probe holder embodying an aspect of the present invention;

FIG. 4 shows a different perspective view of the sensor probe support of FIG. 1;

FIG. 5 shows the sensor probe support of FIGS. 3 and 4, in use, supporting a sensor probe;

FIG. 6 shows a side view of a system including the sensor probe holder of FIGS. 3 and 4;

FIG. 7 shows a view of the bottom of the system of FIG. 6;

FIG. 8 shows the system of FIGS. 5, 6 and 7 in use supported by a wall of a beaker;

FIG. 9 is a schematic showing a cross section of a member of the sensor probe holder of FIGS. 3 and 4;

FIG. 10 shows the sensor probe support of FIGS. 3 and 4, in use, supporting a sensor probe in a conical flask;

FIG. 11 shows the sensor probe support of FIGS. 3 and 4, in use, supporting a sensor probe in a measuring cylinder;

FIG. 12 shows the sensor probe support of FIGS. 3 and 4 in use, supporting a sensor probe in a large wall vessel;

FIG. 12A shows an enlarged portion of FIG. 12;

FIG. 13 shows another view of the sensor probe support of FIGS. 12. and 12A;

FIG. 14 shows another enlarged view of the arrangement of FIGS. 12, 12A and 13;

FIG. 15 shows the sensor probe support of FIGS. 3 and 4, in use, supporting a sensor probe in a beaker; and

FIG. 16 shows the arrangement of FIG. 15 from another side

Like features have been given like reference numerals throughout the drawings.

### DETAILED DESCRIPTION OF THE INVENTION

FIG. 1 illustrates a traditional prior art retort stand 100, as discussed previously in the background of the invention. The stand comprises a weighted base 102 and an upright member 104, which is moveably connected to a bosshead 106. The bosshead is additionally connected to a clamp arm 108, which projects from the bosshead perpendicularly to the upright member and comprises an adjustable clamp 110. The clamp may be adjusted so as to hold a sensor probe. The height of the clamp arm may be adjusted by loosening and moving the bosshead with respect to the upright member.

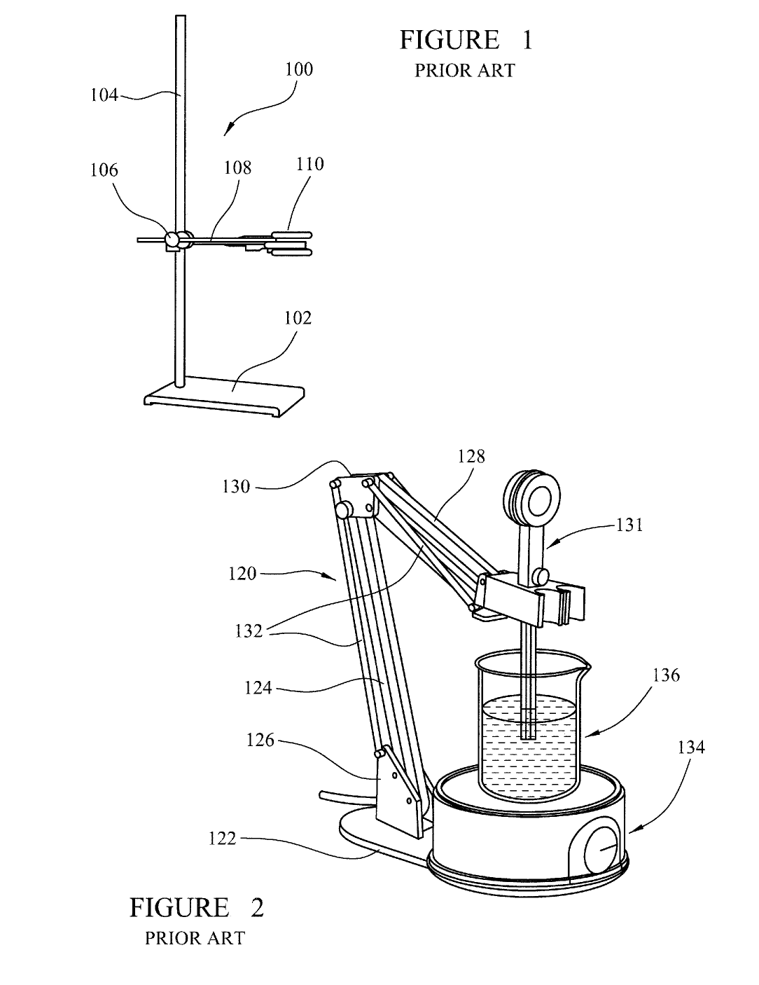

The cantilever-type stand 120 shown in FIG. 2 also forms part of the prior art, as discussed in the background of the invention. The stand comprises a weighted base 122 and a first moveable arm 124 having a lower end and an upper end. The lower end of the first moveable arm is moveably connected to the weighted base by a first moveable joint 126, and the upper end of the first moveable arm is moveably connected to a second moveable arm 128 by a second moveable joint 130. The second moveable arm is connected to a support member which is configured to support a sensor probe 131, for example a wireless sensor probe, as shown. The first and second moveable arms may be moved to a desired position by a user, at which point they are held in position by a number of springs 132. The stand shown in FIG. 2 additionally comprises a magnetic stirrer 134 which may be used in conjunction with a magnet to stir a liquid in a container 136.

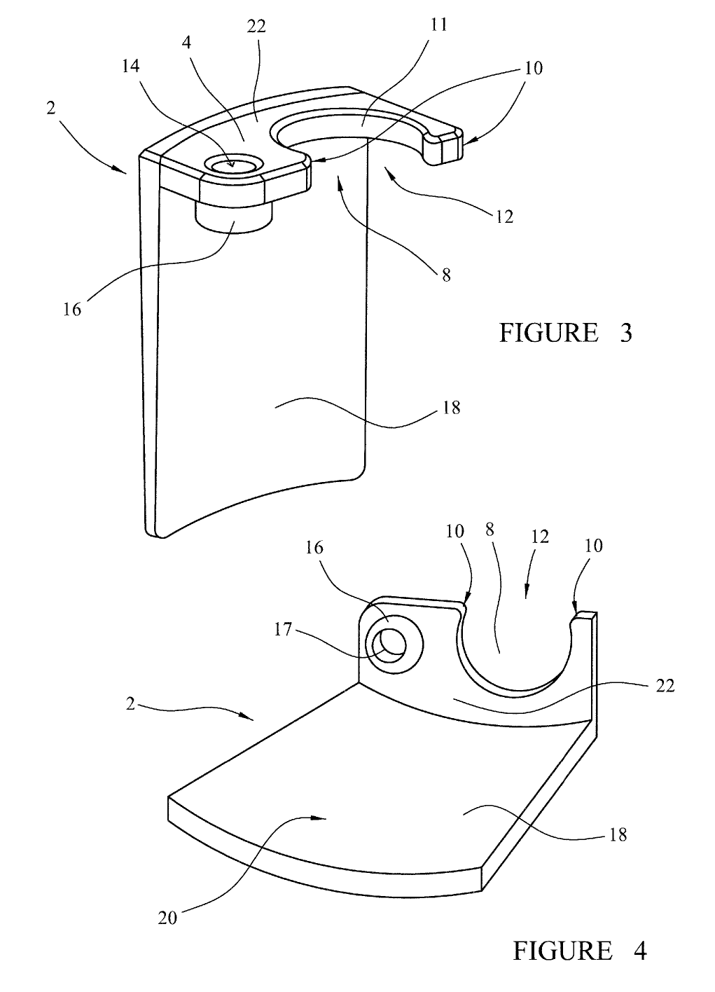

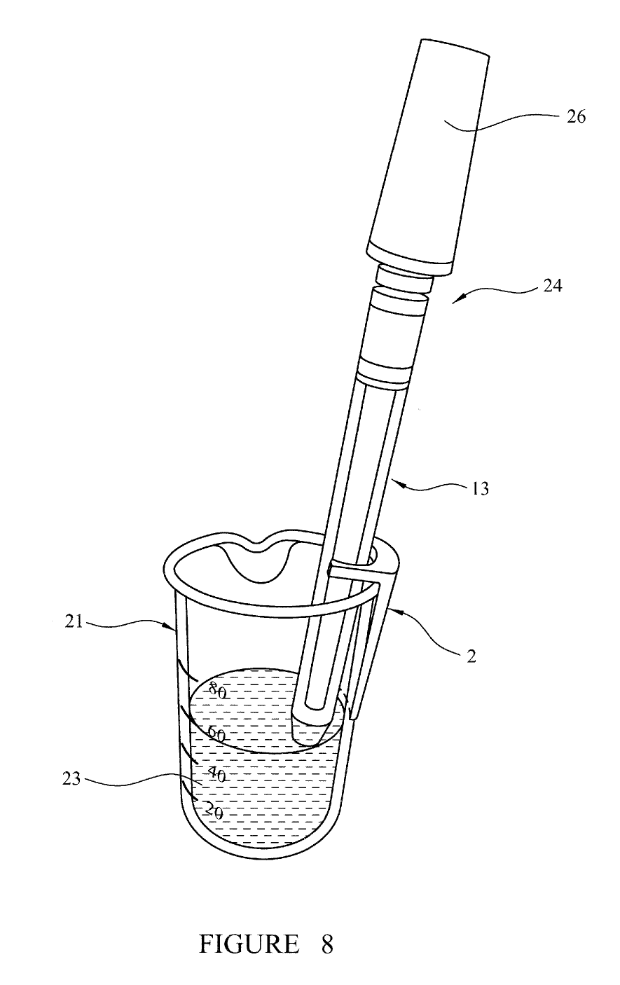

An example sensor probe support will now be described with reference to FIGS. 3 to 9.

As shown in FIGS. 3, 4, and 5, the sensor probe support 2 comprises a connector 4 having a notch or indent 8 formed between a pair of opposing jaws 10, to form a clip connection to a first sensor probe 13. An inner surface 11 of the notch and the jaws form the major arc of a circle, that is, an arc of greater than 180 degrees. The radius of the arc formed by the inner surface of the notch is preferably selected to be equal to, or slightly larger than, the radius of a first cylindrical sensor probe to be connected to the sensor probe support. The space between the opposing jaws forms an opening 12, such that a sensor probe (not shown) may be connected to the sensor probe support by applying a force to insert the sensor probe into the notch through the opening. The opposing jaws are resiliently deformable, so that, in use, they may separate to allow a sensor probe to pass through the opening, and then return to their original shape to retain the sensor probe in the notch. The combination of the radius of the notch and the spring force of the jaws is preferably such that, once connected, a sensor probe is held sufficiently tightly by the connector that it does not move under its own weight. In use, a sensor probe may be removed from the connector by applying a force out of the opening, so that the opposing jaws separate to allow removal of the sensor probe before returning resiliently to their original shape.

The connector 4 additionally comprises a through hole 14 to allow connection to a second sensor probe 15 by sliding the sensor probe into the hole. The hole is circular in shape and extends through a thickened portion 16 of the connector or, in other words, the through hole has a projecting rim, such that an inner edge of the hole forms a cylindrical surface 17. The radius of the hole is preferably selected to be equal to, or slightly larger than, the radius of a second cylindrical sensor probe to be connected to the sensor probe support. The thickened portion of the connector has a greater thickness in the direction of the central axis of the hole than the rest of the connector, so that a sensor probe inserted into the hole may contact the cylindrical surface over a greater surface area than would be the case, were the hole formed in a non-thickened portion of the connector. This increased thickness therefore functions to restrict the lateral movement of a sensor probe inserted into the hole, so as to stabilise the sensor probe support with respect to a connected sensor probe.

A member 18 having a curve transverse surface 20 is connected to a spacing portion 22 of the connector 4 forming an end of the connector. The member projects perpendicular and longitudinal to the connector. The cross section of the connector and member is generally L shape. The member projects from the connector in a direction that is parallel to the axis of the through hole 14.

The spacing portion of the connector 4 creates a spacing between the notch 8 and the member 18, and between the hole 14 and the member, so that, in use, the member is spaced from both a connected first sensor probe and a connected second sensor probe.

In this example, the radius of the major arc formed by the notch 8 is approximately 6.1 mm, in order to accommodate a commercially available, laboratory grade, pH sensor probe or other electro-chemical probe with a standard diameter of 12 mm. In this example, the radius of the through hole 14 is approximately 1.5 to 2 mm, in order to accommodate a commercially available, laboratory grade, temperature sensor probe with a standard diameter of 3 to 4 mm.

The connector 4 and the member 18 of the sensor probe support 2 are formed from the same material. They are integral. The connector and the member may be formed from a single piece of the same material, in this example, plastics. The sensor probe support is a one-piece or unitary device.

In use, the sensor probe support 2 is connected to a first sensor probe 13, in this example, in the form of a cylindrical electrochemical sensor probe having a distal end and a proximal end, by positioning the sensor probe to abut the opposing jaws 10 of the connector and applying a force in the direction of the notch 8, so that the opposing jaws resiliently separate to allow the sensor probe to pass through the opening 12 into the notch. Once the sensor probe has been inserted into the notch, the opposing jaws return to their original shape so as to retain the sensor probe in the notch. As the diameter of the major arc formed by the notch is chosen to be only slightly greater than the diameter of the first sensor probe, the surface of the sensor probe contacts the inner surface 11 of the notch around the entire length of the notch. The slight difference in diameters means that the connector is moveable along the axis of the sensor probe upon application of a force by a user. However, the fit between the first sensor probe and the connector is sufficiently tight, and the frictional force between the sensor probe and the connector is sufficiently high that when a force is not applied by a user the sensor probe support remains in place on the sensor probe, and the first sensor probe is retained within the notch.

In use, the sensor probe support 2 is connected to a second sensor probe 15, in this example, a cylindrical temperature sensor probe having a distal end and a proximal end, by sliding the distal end of the probe through the through hole 14 in the connector 4. As the diameter of the through hole is chosen to be only slightly greater than the diameter of the second sensor probe, the surface of the sensor probe contacts the cylindrical inner surface 17 of the hole around the entire circumference of the sensor probe. The slight difference in diameters means that the connector is moveable along the axis of the probe upon application of a force by a user. However, the fit between the temperature probe and the connector is sufficiently tight, and the frictional force between the sensor probe and the connector is sufficiently high that when the force is removed the sensor probe support remains in place on the sensor probe, and the second sensor probe is retained within the hole.

The thickened portion of the connector 4 in contact with the second sensor probe 15 restricts, or completely eliminates, lateral movement of the sensor probe support 2 with respect to both the first and second sensor probes. This stabilises the support with respect to both probes, such that the connector 4 and the member 18 are rigidly connected to the sensor probes.

Once the first 13 and second 15 sensor probes are connected to the connector 4, the sensor probes may be moved, or adjusted, so that the sensor probe support 2 is positioned at a position on the sensor probes that is appropriate for use. The positions of the sensor probes may be adjusted by applying a force to either the connector or a sensor probe, such that the connector or probe move with respect to one another. The first sensor probe 13 is removed from the connector 4 and reconnected by clipping on the connector at an appropriate position. The second sensor probe is adjustable by sliding the connector towards either the distal or the proximal end of the sensor probe, and removable by sliding the connector off the distal end of the sensor probe. The sensor probes may be adjusted within the connector so that the distal ends of the first and second sensor probes are aligned.

A position that is appropriate for use may mean that the sensor probe support 2 is connected to the sensor probes 13,15 at a desired height, such that when the sensor probe is supported using a wall, in use, the distal ends of the sensor probes are at a desired height. For example, the sensor probes may be supported at a height such that the probe tips are immersed in a liquid sample to be measured or to calibrate a sensor probe.

In use, the sensor probe support 2 and connected first and second sensor probes 13,15 is supported by a wall by locating the wall between the sensor probes and the member. In other words, a wall is located such that the distal ends of the first and second sensor probes are positioned on one side of the wall (an inner part of the wall), while the member is positioned on the other side of the wall (an outer side of the wall). Once a suitable wall is located between the sensor probes and the member, the sensor probe support is lowered until an upper edge of the wall contacts the underside of the connector 2. Particularly, the wall contacts the underside of the spacing portion 22. The sensor probe support may then be released, so that the weight of the sensor probe support and the connected first and second sensor probes is supported by the wall. As the frictional force between the sensor probe support and the sensor probes is greater than the weight of the probes, the sensor probes are retained in position in the connector when the support is supported by a wall.

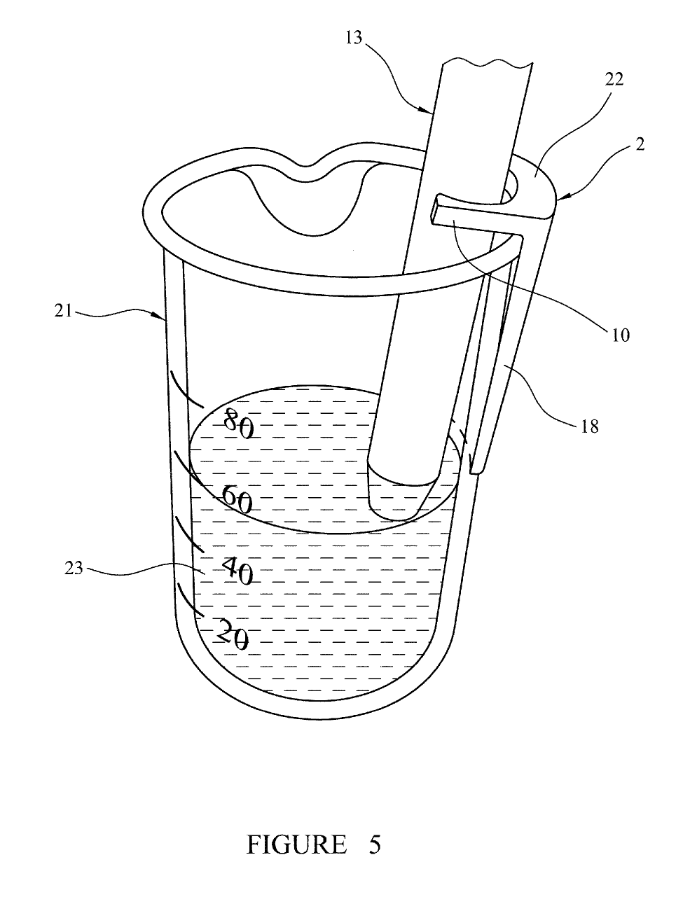

Preferably, the sensor probe support 2 may be supported using the wall of a container 21, as shown in FIG. 5. Particularly preferably, the sensor probe support may be supported using the wall of a container containing a sample to be measured by the sensor probes.

Preferably, the sensor probe support may be supported using the wall of a sample container such that the distal ends of the sensor probes are immersed in, or held below the surface of, a liquid sample 23. In this example, a stirrer in the form of a magnet for a magnetic stirrer can be used effectively in the container despite the presence of the sensor probe in the container.

Preferably the sensor probe support is suitable for use with a variety of containers with a variety of curvatures, and with or without lips or rims.

The dimensions of the spacing portion and of the member are chosen so that the walls of a range of typical containers may be locatable between the member and any sensor probes connected to the sensor probe support. Preferably, the spacing portion may be sized to accommodate common glass or Pyrex (registered trade mark) beakers or the like with curved lips, for example beakers with a capacity of 50 ml, or 100 ml, or 200 ml, or 250 ml, or 500 ml, or any other standard size of laboratory container.

Importantly, the curvature of a curve container wall may vary depending on the volume of the container. The dimensions of the spacing portion, and the curvature of the member, are therefore preferably chosen so that the sensor probe support may be supported using both a straight wall, which is a wall with zero curvature, and a cylindrical sample tube with a small radius and a large curvature. Containers with wall curvatures intermediate to these two situations may also fit between the member and connected sensor probes, so that they might be used to support the sensor probe support.

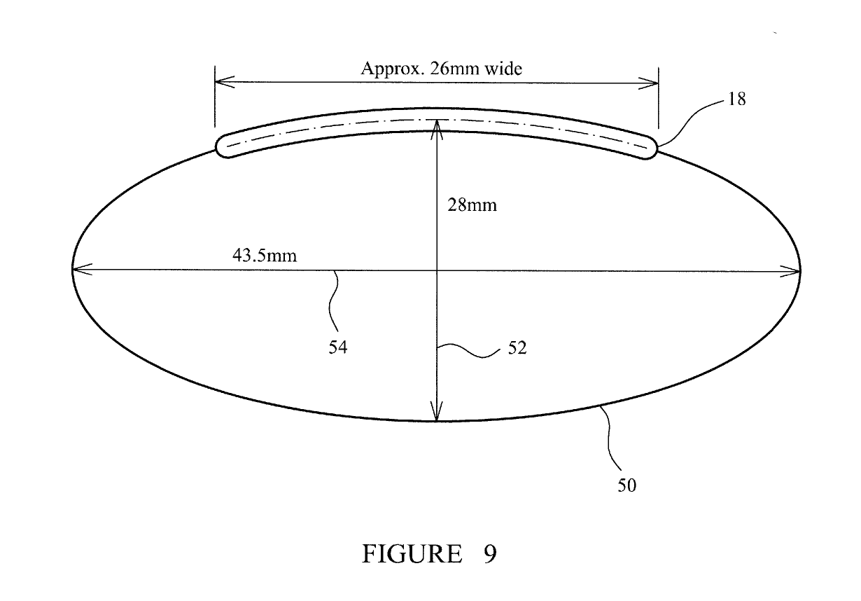

As illustrated in FIG. 9, the transverse width of the member 18 is chosen to be 26 mm. The curve transverse surface of the member is in the shape of a section of an ellipse 50 that is 26 mm wide and the ellipse has a minor axis 52 of length 28 mm and a major axis 54 of length 43.5 mm. The member is formed as a 26 mm wide section symmetrical around, or bisected by, the minor axis of the ellipse. These dimensions are chosen so as to provide a high degree of physical stability and support to the sensor probe support and connected sensor probes, in use, when they are supported by a wall. The curve transverse surface increases the stability of the apparatus when it is supported by a curve wall, as the member may abut the supporting wall over a large surface area, so as to prevent movement of the sensor probes over a wide range of angles. The longitudinal length of the member is chosen to be 41.5 mm.

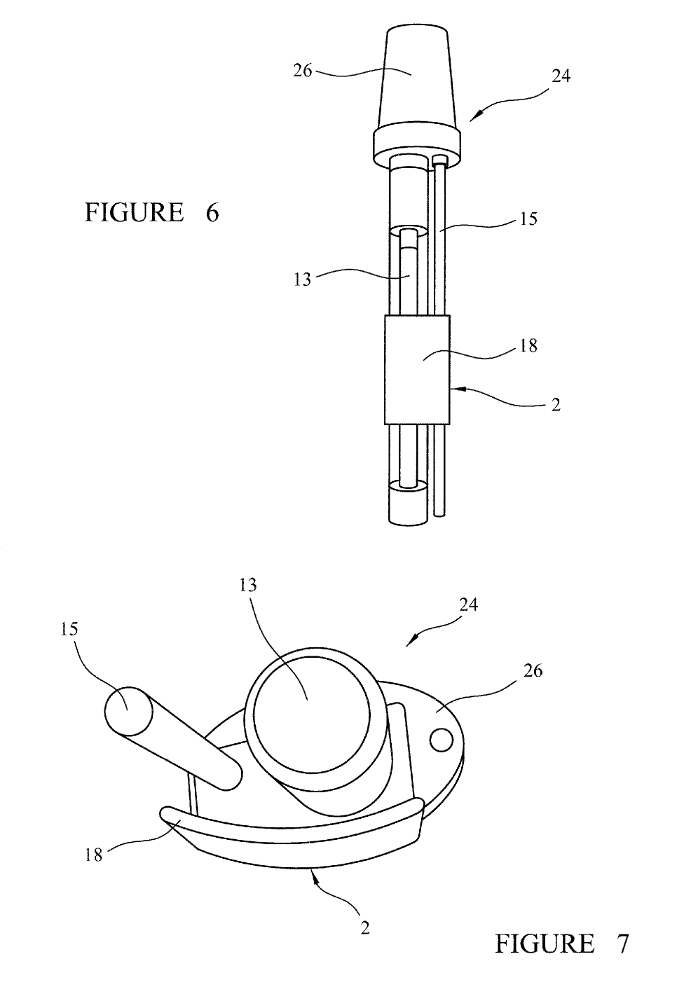

One embodiment of the sensor probe support according to the present invention is as part of a system 24 illustrated in FIGS. 6, 7 and 8. The system comprises the sensor probe support 2 of FIGS. 3, 4, 5 and 9, a first sensor probe 13 and a second sensor probe 15, and an adaptor or cap 26 for providing a wireless connection to a computing device such as by Bluetooth. The cap is located at the proximal end of the sensor probes and is electrically connected to them. The first sensor probe or electrochemical sensor probe 13 is mechanically connected to the adaptor by a screw thread (not shown) so that it can be easily interchanged in conjunction with the sensor probe support for connection to the connector. The first sensor probe or electrochemical sensor probe may be mechanically connected to the adaptor by other means, such as twist thread, an S7 or BNC connector, or by various other types of commercially available sensor probe connector.

As mentioned above, in order to be usable with a variety of containers over a wide range of container-volumes, the sensor probe support is able to accommodate walls over a large range of curvatures. The support is also able to accommodate common container features such as flat, rounded or curved lips, or rims, which are common on laboratory glassware and plasticware.

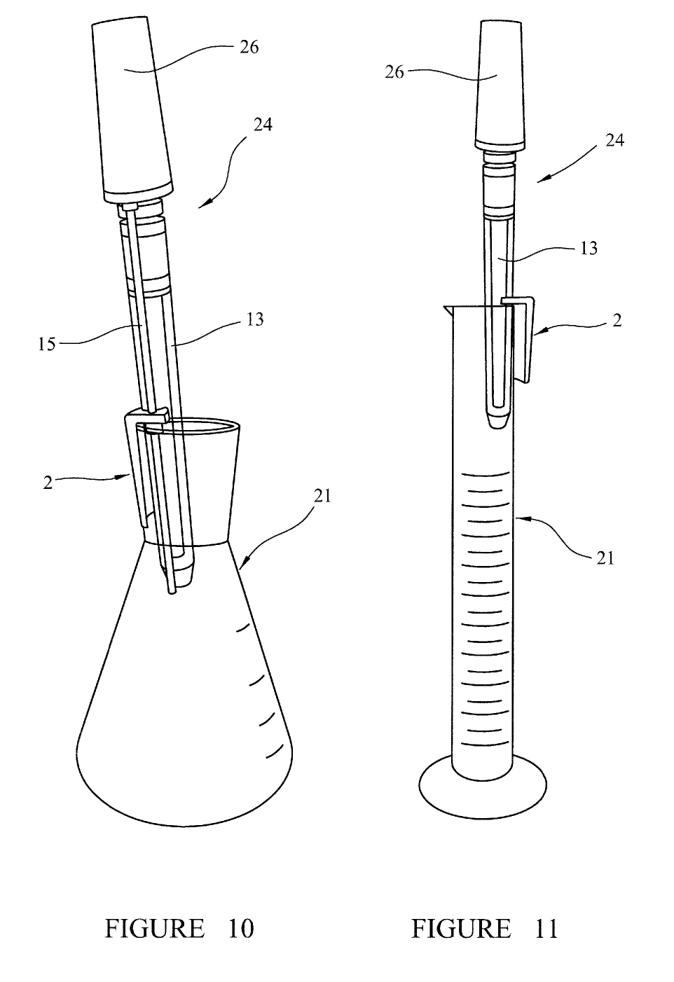

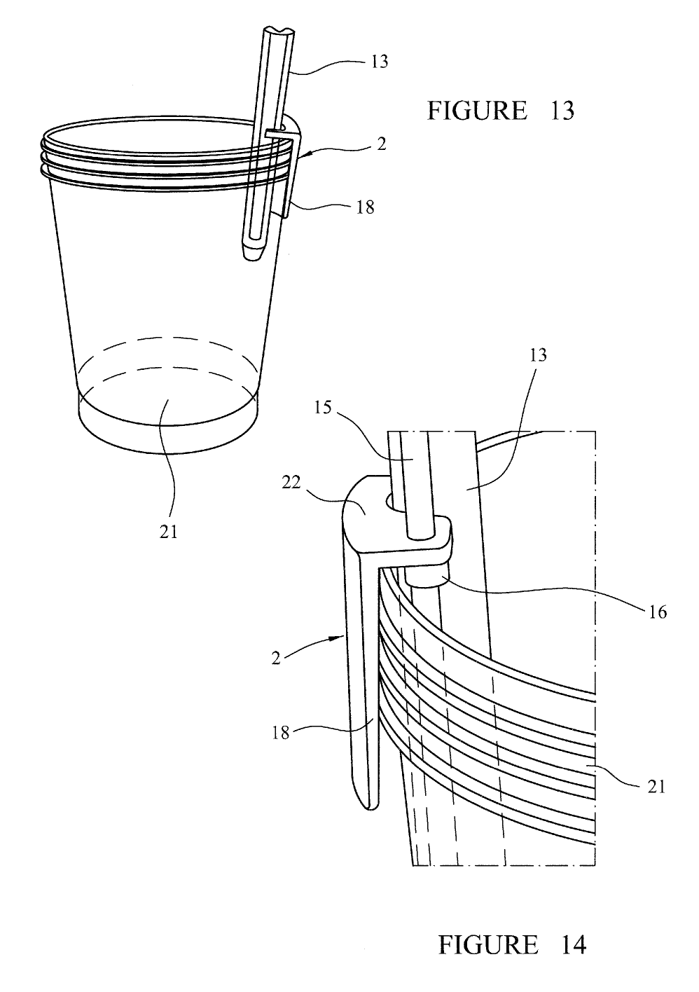

The variety of containers that can be used with the sensor probe support 2 and thus its versatility is illustrated by FIGS. 10 to 16.

FIG. 10 illustrates the sensor probe support 2 in use with a narrow neck, wide bottom or conical flask 21. FIG. 11 illustrates the sensor probe support 2 in use with a measuring cylinder 21. Both of the examples have a pronounced rim or projecting rim. As illustrated in these Figures, a rim or side portion of the temperature sensor 13 comes into contact with the wall of the container when using a thicker beaker or with a rim or thicker wall. In such a case the sensor protrudes into the beaker at an approximately 10 to 15 degree angle. The member 18 of the support is less than perpendicular (less than 90 degrees) to the connector 22 (typically 85 to 87 degrees) and the end part is distorted outwards. There are 3 touch points: 1) the bottom of the member 18, 2) the spacing portion of the connector 22, and 3) the top of the member 18.

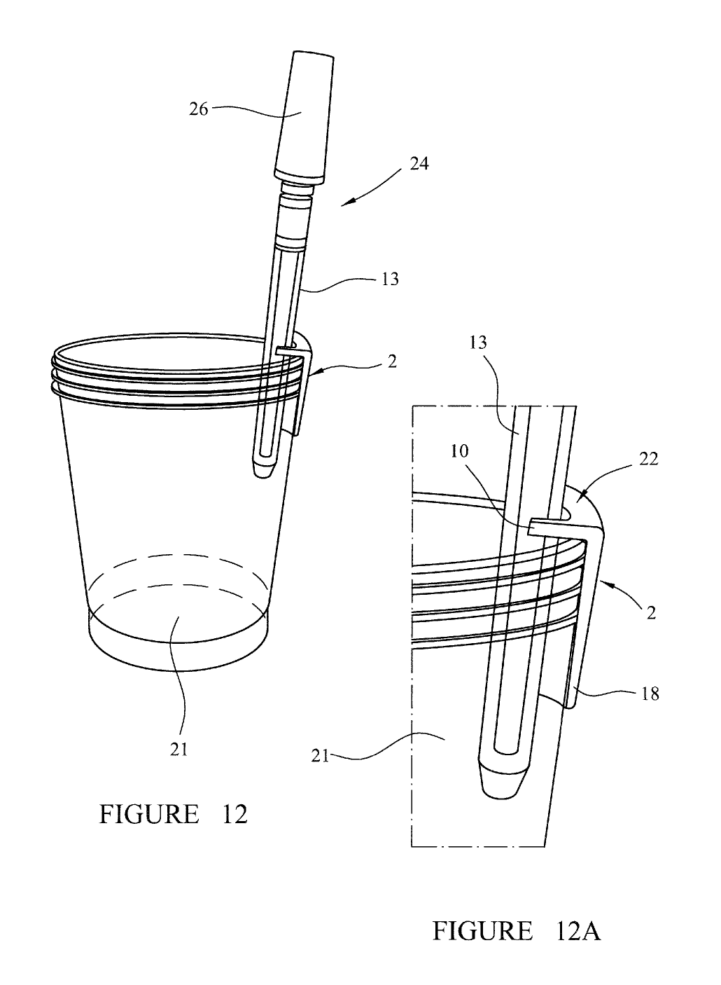

FIGS. 12 and 12A, 13 and 14 illustrate the sensor probe support 2 in use with a large wall vessel 21. This vessel has a 700 ml capacity and a thick rim. With a large beaker or a thick walled vessel (at a wall thickness equal to or larger than the spacing portion (for example, a vessel size of 700 ml to 1000 ml)) with or without rim or screw threads for a closure cap (sample container), the sensor probe support or holder works differently. It is wedged or forced on to the wall touching at the sensor and does not touch the connector part at all of the sensor probe support, but only at the centre of the member. This extends the member part outwards to make a tight fit and the electrode is at an angle of around 10 to 15 degrees.

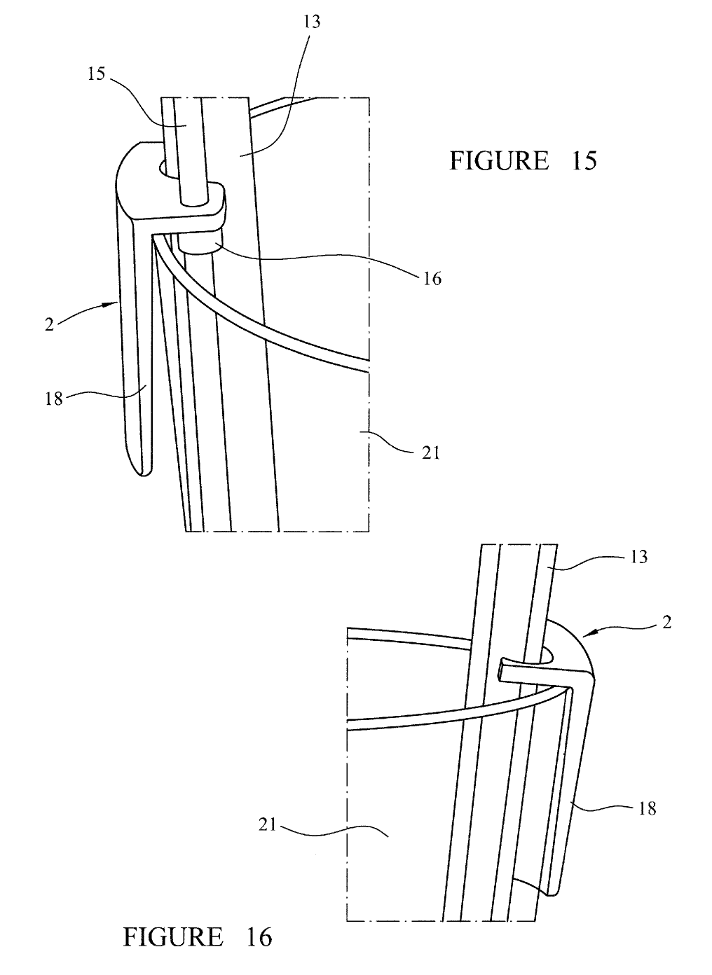

When using it with a straight wall beaker (FIGS. 15 and 16), the touch point drops to one on the sensor probe support or holder 2 (only on the spacing portion of the connector 22) and a second touch point on the sensor probe 13 (in this example a pH sensor probe) itself, the probe is then vertical or beyond vertical slightly by around 1 to 5 degrees. The system is the sensor probe and the sensor probe support or holder working together to provide stability.

The limiting feature of the example is the space between the thickened rim 16 of the through hole for the temperature sensor 15 and the member 18. Different space sizes between the thickened rim and the member or member lengths may be provided to allow different size vessels to be used with different thickness walls and different positioning and/or angle of sensor probe or electrode.

A sensor probe support or holder for supporting or holding two sensor probes has been described. A sensor probe support may be provided for supporting or holding a single sensor probe, for example an electrochemical sensor, such as a pH sensor or a combination pH sensor. In this case, a connector with a single clip-on notch portion or notch 8 is provided at the centre or the connector 2 and the single sensor probe may be located in this clip-on notch portion. There is not the through hole for a second sensor probe as described in the example above.

Sensor clips or sensor probe supports each of different colours and/or sizes may be provided. These would help to identify multiple and different sensor probes and cap combinations. Bar codes and/or QR codes to identify the supports may be provided on the member of a sensor probe support to identify it. The name or logo of the manufacturer, or of some other commercial entity, or branding may be provided on the member of a support to fulfil an advertising or branding function. Plural sensor probe supports may be provided in a kit of parts, such as in a pack of five sensor probe supports, which may also include a cap or wireless adapter for wireless communication connection between the sensor probe or probes and a meter.

The sensor probe support may also be configured such that the sensor probe or probes are located in the centre of a beaker or container.

Embodiments of the present invention have been described. It will be appreciated that variations and modifications may be made to the described embodiments within the scope of the present invention.

1. A sensor probe support for supporting a sensor probe using a wall, the sensor probe support comprising:
a member; and
a connector to moveably connect the member to and space the member from a sensor probe, the member projecting from the connector;
wherein, in use, a wall is located between a sensor probe and the member to support the sensor probe.

2. A sensor probe support for supporting a sensor probe using a wall, the sensor probe support comprising:
a member comprising a curve transverse surface; and
a connector to connect the member to and space the member from a sensor probe, the member projecting longitudinally from the connector;
wherein, in use, a wall is located between a sensor probe and the curve surface of the member to support the sensor probe.

3. A sensor probe support for supporting at least two sensor probes using a wall, the sensor probe support comprising:
a member; and
a connector to connect the member to and space the member from at least two sensor probes, the member projecting from the connector;
wherein, in use, a wall is located between the at least two sensor probes and the member to support the at least two sensor probes.

4. A sensor probe support for supporting a sensor probe using a wall, the sensor probe support comprising:
at least one member; and
a connector to connect the at least one member to and space the at least one member from a sensor probe, the at least one member projecting from the connector;
wherein, in use, a wall is located between the sensor probe and the at least one member, such that there are at least two points of contact between:
the wall and the sensor probe support and the wall and the sensor probe; or
the wall and the sensor probe support.

5. A sensor probe support according to claim 1, 2 or 4, in which the connector connects the member to and spaces the member from at least two sensor probes.

6. A sensor probe support according to claim 1, 2 or 4, in which the connector connects the member to and spaces the member from a single sensor probe, wherein the sensor probe is connected to a central portion of the connector.

7. A sensor probe support according to claim 1, or any of claims 3 to 6, in which the member projects longitudinally from the connector and comprises a curve transverse surface.

8. A sensor probe support according to any of claims 2 to 7, in which the connector is moveably connectable to a sensor probe.

9. A sensor probe support according to any preceding claim, in which the connector and the member are integral.

10. A sensor probe support according to any preceding claim, in which the connector is connectable to a sensor probe, the sensor probe having a longitudinal axis, so that the member projecting from the connector projects in a direction that is parallel to the longitudinal axis of the sensor probe.

11. A sensor probe support according to any preceding claim, in which the connector spaces the member from a sensor probe in a connector plane, wherein the member projects from the connector in a plane perpendicular to the connector plane.

12. A sensor probe support according to any preceding claim, in which the connector spaces the member from a sensor probe by a spacing of 1 cm or less.

13. A sensor probe support according to any preceding claim, in which the connector comprises a through hole with a circular circumference to connect the member to a sensor probe such as a temperature probe or the like.

14. A sensor probe support according to claim 13, in which the through hole comprises an outwardly projecting rim.

15. A sensor probe support according to any preceding claim, in which the connector comprises an indent to connect the member to a sensor probe such as an electrochemical sensor or the like.

16. A sensor probe support according to claim 15, in which the indent has a partially circular edge with an opening facing away from the member at its free ends.

17. A sensor probe support according to claim 16, in which the free ends are resilient to allow a sensor probe to be entered into the indent and to be held in the indent.

18. A sensor probe support according to any preceding claim, wherein the sensor probe is a wireless sensor probe such as a Bluetooth or WiFi wireless sensor probe or the like.

19. A method of supporting a sensor probe using a wall, comprising the steps of:
connecting a sensor probe to a sensor probe support using a connector, such that a member projecting from the connector is connected to and spaced from the sensor probe; and
locating a wall between the sensor probe and the member, such that the sensor probe and sensor probe support are supported by the wall.

20. A system for providing a measurement from a sensor probe comprising at least one sensor probe connected to a sensor probe support according to any of claims 1 to 18.

21. A sensor probe support according to claim 1, 2 or 3, wherein, in use, a wall is located between the sensor probe and the at least one member, such that there are at least two points of contact between:
the wall and the sensor probe support and the wall and the sensor probe; or
the wall and the sensor probe support.
